(19) United States
(12) Patent Application Publication
(10) Pub. No.: US 2020/0330929 A1
(43) Pub. Date: Oct. 22, 2020

(54) ION EXCHANGE MEMBRANE, METHOD OF MAKING THE ION EXCHANGE MEMBRANE, AND FLOW BATTERY COMPRISING THE ION EXCHANGE MEMBRANE

(71) Applicant: ROGERS CORPORATION, Chandler, AZ (US)

(72) Inventors: Wei Wang, Waltham, MA (US); Hongli Zhu, Arlington, MA (US)

(21) Appl. No.: 16/821,446

(22) Filed: Mar. 17, 2020

Related U.S. Application Data
(60) Provisional application No. 62/836,127, filed on Apr. 19, 2019.

(51) Int. Cl. B01D 67/00; H01M 8/18; C08J 5/22

(52) U.S. Cl. CPC B01D 67/0006; H01M 8/188; C08J 2327/16; C08J 5/2243; B01D 2325/42; C08J 5/2225

(57) ABSTRACT

An ion exchange membrane includes a matrix including a fluorinated polymer and a filler including cellulose nanocrystals. A method of making the ion exchange battery includes coating a solution including the fluorinated polymer and the cellulose nanocrystals onto a substrate, removing solvent from the coated substrate to provide the membrane, and removing the membrane from the substrate. The ion exchange membrane can be useful for a variety of applications including fuel cells, sensors, electrolytic cells, redox flow batteries, gas separators, humidifiers, and metal ion batteries.

### CROSS-REFERENCE TO RELATED APPLICATION

This application claims priority to U.S. provisional application No. 62/836,127, filed on Apr. 19, 2019, the entire content of which is hereby incorporated by reference in its entirety.

### BACKGROUND

This application relates to ion exchange membranes for redox flow batteries, methods for their manufacture, and batteries using the ion exchange membranes.

Redox flow batteries (RFB) are attractive for large scale energy storage because of their excellent electrochemical reversibility, long life, high efficiency, and reliable operation. Wide scale operation of RFBs has been burdened by the high cost and low selectivity of commonly used ion exchange membranes, such as those prepared from perfluorosulfonic acid polymers and copolymers. Ion exchange membranes act as a physical barrier separating the positive and negative cells while allowing for the migration of charge-balancing ions from one side to the other to complete the internal circuit of the cell. Thus, the performance of an ion exchange membrane can impact the overall performance of a redox flow battery.

Accordingly, there have been significant efforts towards developing low-cost ion exchange membranes possessing high chemical stability, high selectivity, and excellent ion conductivity in strong acidic environments. The design of a chemically stable ion exchange membrane with high ion selectivity, particularly for use in aqueous redox flow batteries, remains a challenge.

### SUMMARY

An ion exchange membrane comprises a matrix comprising a fluorinated polymer; and a filler comprising cellulose nanocrystals.

A method of making the ion exchange membrane comprises coating a solution comprising a solvent, the fluorinated polymer, and the cellulose nanocrystals onto a substrate; removing the solvent from the coated substrate to provide the membrane; and removing the membrane from the substrate.

A fuel cell, a sensor, an electrolytic cell, a redox flow battery, a gas separator, a humidifier, or a metal ion battery comprises the ion exchange membrane.

A flow battery comprises the ion exchange membrane.

The above described and other features are exemplified by the following figures, detailed description, and claims.

### BRIEF DESCRIPTION OF THE DRAWINGS

The following figures represent exemplary embodiments.

FIG. 1A is a schematic illustration of (a) a composite membrane comprising cellulose nanocrystals and a fluorinated polymer matrix and (b) an ion transport mechanism in the composite membrane.

FIG. 1B is a chemical structure of cellulose nanocrystals prepared by acid hydrolysis using sulfuric acid.

FIG. 1C shows utilization of the composite membrane in a flow battery.

FIG. 2A shows a digital photograph of a cellulose nanocrystal dispersion in aqueous solution.

FIG. 2B shows a digital photograph of freeze-dried cellulose nanocrystals.

FIG. 2C shows a digital photograph of a cellulose nanocrystal/poly(vinylidene fluoride) composition.

FIG. 2D shows a digital photograph of a cellulose nanocrystal/poly(vinylidene fluoride) composite membrane prepared by solution casting of the cellulose nanocrystal/poly(vinylidene fluoride) composition, followed by calendering.

FIG. 2E shows an atomic force microscope image of cellulose nanocrystals.

FIG. 2F shows a transmission electron microscope image of a dried dispersion of cellulose nanocrystals.

FIG. 2G shows a high magnification transmission electron microscope image of cellulose nanocrystals.

FIG. 2H shows a scanning electron microscope image of the cross-section of cellulose nanocrystal/poly(vinylidene fluoride) composite membrane before calendering at different magnifications.

FIG. 2I shows a scanning electron microscope image of the cross-section of cellulose nanocrystal/poly(vinylidene fluoride) composite membrane after calendering.

FIG. 2J shows a scanning electron microscope image of the cross-section of the NAFION 115 membrane.

FIG. 2K shows a scanning electron microscope image of the surface of the cellulose nanocrystal/poly(vinylidene fluoride) composite membrane before calendering.

FIG. 2L shows a scanning electron microscope image of surface of the cellulose nanocrystal/poly(vinylidene fluoride) composite membrane after calendering.

FIG. 2M shows a scanning electron microscope image of surface of the NAFION membrane.

FIG. 3A shows stress vs. strain curves for cellulose nanocrystal/poly(vinylidene fluoride) (CNC/PVDF) composite membranes containing various cellulose nanocrystal content.

FIG. 3B shows a scanning electron microscope image of the cross-section of a fractured region of a calendered membrane.

FIG. 3C shows the area resistance of membranes with various cellulose nanocrystal (CNC) content, a NAFION membrane, and a calendered membrane.

FIG. 3D shows vanadium ion (VO²⁺) permeability of the membranes in a period of 24 hours.

FIG. 4A illustrates the performance of vanadium redox flow batteries assembled using a cellulose nanocrystal composite membrane, a calendered membrane and commercial NAFION 115 membranes in terms of current rate performance.

FIG. 4B illustrates the performance of vanadium redox flow batteries assembled using a cellulose nanocrystal composite membrane, a calendered membrane and commercial NAFION 115 membranes in terms of charge-discharge profiles at different current densities of 40, 60, 80, and 100 milliamperes per centimeter squared (mA cm⁻²).

FIG. 4C illustrates the performance of vanadium redox flow batteries assembled using a cellulose nanocrystal composite membrane, a calendered membrane and commercial NAFION 115 membranes in terms of a comparison of charge-discharge profiles at 80 mA cm⁻².

FIG. 4D illustrates the performance of vanadium redox flow batteries assembled using a cellulose nanocrystal composite membrane, a calendered membrane and commercial NAFION 115 membranes in terms of coulombic efficiency.

FIG. 4E illustrates the performance of vanadium redox flow batteries assembled using a cellulose nanocrystal composite membrane, a calendered membrane and commercial NAFION 115 membranes in terms of voltage efficiency.

FIG. 4F illustrates the performance of vanadium redox flow batteries assembled using a cellulose nanocrystal composite membrane, a calendered membrane and commercial NAFION 115 membranes in terms of energy efficiency at different current densities of 40, 60, 80, and 100 mA cm⁻².

FIG. 4G illustrates the performance of vanadium redox flow batteries assembled using a cellulose nanocrystal composite membrane, a calendered membrane and commercial NAFION 115 membranes in terms of cycling stability representing the discharge capacity and coulombic efficiency for 120 continuous charge-discharge cycling at 100 mA cm⁻².

FIG. 5A is a digital picture of a 45-C-CNC/PVDF membrane and NAFION membrane after cycling showing postmortem analysis of a calendered cellulose nanocrystal composite membrane before and after cycling the flow battery.

FIG. 5B shows a stress vs. strain curve of a 45-C-CNC/PVDF membrane before and after cycling.

FIG. 5C shows X-ray diffraction patterns of a 45-C-CNC/PVDF membrane before and after cycling.

FIG. 5D shows Fourier transform infrared spectroscopy of a 45-C-CNC/PVDF membrane before and after cycling.

### DETAILED DESCRIPTION

A novel strategy was developed for fabricating highly ion selective composite membranes utilizing super-hydrophilic cellulose nanocrystals (CNC) enmeshed in a hydrophobic, fluorinated polymer matrix. This approach provides flexibility, mechanical strength, and structural robustness to the membranes. The membranes are useful for a variety of applications including, fuel cells, sensors, electrolytic cells, redox flow batteries, gas separators, humidifiers, or metal ion batteries. The membranes are particularly well suited for use in redox flow batteries.

Accordingly, an aspect of the present disclosure is an ion exchange membrane comprising a matrix and a filler. The matrix comprises a fluorinated polymer, also known as a fluoropolymer. “Fluoropolymers” as used herein include homopolymers and copolymers that comprise repeat units derived from a fluorinated alpha-olefin monomer, i.e., an alpha-olefin monomer that includes at least one fluorine atom substituent, and optionally, a non-fluorinated, ethylenically unsaturated monomer reactive with the fluorinated alpha-olefin monomer. Exemplary fluorinated alpha-olefin monomers include CF₂═CF₂, CHF═CF₂, CH₂═CF₂, CHCl═CHF, CClF═CF₂, CCl₂═CF₂, CClF═CClF, CHF═CCl₂, CH₂═CClF, CCl₂═CClF, CF₃CF═CF₂, CF₃CF═CHF, CF₃CH═CF₂, CF₃CH═CH₂, CHF₂CH═CHF, and CF₃CH═CH₂, and perfluoro(C₂₋₈ alkyl)vinyl ethers such as perfluoromethyl vinyl ether, perfluoropropyl vinyl ether, and perfluorooctylvinyl ether. In some embodiments, the fluorinated alpha-olefin monomer comprises tetrafluoroethylene (CF₂═CF₂), chlorotrifluoroethylene (CClF═CF₂), (perfluorobutyl)ethylene, vinylidene fluoride (CH₂═CF₂), hexafluoropropylene (CF₂═CFCF₃), or a combination thereof. Exemplary non-fluorinated monoethylenically unsaturated monomers include ethylene, propylene, butene, and ethylenically unsaturated aromatic monomers such as styrene and alpha-methyl-styrene. Exemplary fluoropolymers include poly(chlorotrifluoroethylene) (PCTFE), poly(chlorotrifluoroethylene-propylene), poly(ethylene-tetrafluoroethylene) (ETFE), poly(ethylene-chlorotrifluoroethylene) (ECTFE), poly(hexafluoropropylene), poly(tetrafluoroethylene) (PTFE), poly(tetrafluoroethylene-ethylene-propylene), poly(tetrafluoroethylene-hexafluoropropylene) (also known as fluorinated ethylene-propylene copolymer (FEP)), poly(tetrafluoroethylene-propylene) (also known as fluoroelastomer) (FEPM), poly(tetrafluoroethylene-perfluoropropylene vinyl ether), a copolymer having a tetrafluoroethylene backbone with a fully fluorinated alkoxy side chain (also known as a perfluoroalkoxy polymer (PFA)) (for example, poly(tetrafluoroethylene-perfluoropropylene vinyl ether)), polyvinylfluoride (PVF), polyvinylidene fluoride (PVDF), poly(vinylidene fluoride-chlorotrifluoroethylene), poly(vinylidene fluoride-hexafluoropropylene), perfluoropolyether, perfluorosulfonic acid, and perfluoropolyoxetane. A combination comprising at least one of the foregoing fluoropolymers can be used. The fluorinated polymers can be fibril forming or non-fibril forming. In an aspect, the fluorinated polymer comprises poly(vinylidene fluoride-hexafluoropropylene), poly(tetrafluoroethylene), or a combination thereof. In a specific aspect, the fluorinated polymer comprises poly(vinylidene fluoride-hexafluoropropylene).

The matrix can optionally exclude any polymer other than the fluorinated polymer. For example, in an aspect, the matrix can exclude a perfluorosulfonic acid-poly(tetrafluoroethylene) copolymer, for example such as that available under the tradename NAFION from Dupont.

The ion exchange membrane includes the matrix in an amount of 20 to 70 weight percent, based on the total weight of the ion exchange membrane. Within this range, the matrix can be present in an amount of 30 to 70 weight percent, or 35 to 70 weight percent, or 40 to 70 weight percent, or 45 to 65 weight percent, or 50 to 60 weight percent, each based on the total weight of the ion exchange membrane.

The ion exchange membrane also includes a filler comprising cellulose nanocrystals. Cellulose nanocrystals are derived from cellulose. As used herein, the term “cellulose nanocrystals” can include all cellulose nanocrystals made from different sources, including wood, plants, tunicates, algae, bacteria, and the like. Cellulose nanocrystals can be obtained by various processes, including by chemical hydrolysis of the cellulose source under harsh acidic conditions (e.g., using sulfuric acid, hydrochloric acid, phosphoric acid, or hydrobromic acid). The cellulose nanocrystals can generally possess any shape. In an aspect, the cellulose nanocrystals can be rod-like. Exemplary dimensions for cellulose nanocrystals can be, for example, 1 to 100 nanometers (nm), or 5 to 50 nm, or 5 to 30 nm, or 10 to 20 nm in cross-sectional diameter and from tens of nanometers to several micrometers in length, for example having an average length of 50 to 750 nm, or 75 to 500 nm, or 90 to 300 nm, or 100 to 200 nm, or 500 to 2500 nm, or 750 to 2500 nm, or 800 to 2250 nm, or 1000 to 2000 nm. Cellulose nanocrystals are generally characterized by a high degree of crystallinity. In an aspect, the cellulose nanocrystals can be prepared by chemical hydrolysis using sulfuric acid, and thus comprise a plurality of pendant hydroxyl (—OH) and sulfonic acid (—SO₃H) groups.

In an aspect, in addition to the cellulose nanocrystals, the filler can optionally further comprise one or more additional fillers. When present, additional fillers are preferably hydrophilic. The optional one or more additional fillers can be modified, for example to include hydroxyl (—OH) or sulfonic acid (—SO₃H) acid Exemplary fillers can include, for example, alumina, silica, titania, boehmite, zirconium oxide, and the like, or a combination thereof. In an aspect, fillers other than the cellulose nanocrystals can be excluded.

The filler comprising cellulose nanocrystals can be present in the ion exchange membrane in an amount of 30 to 80 weight percent, based on the total weight of the ion exchange membrane. Within this range, the filler can be present in an amount of 30 to 70 weight percent, or 30 to 65 weight percent, or 30 to 60 weight percent, or 35 to 55 weight percent, or 40 to 50 weight percent, each based on the total weight of the ion exchange membrane.

The membrane can be porous or nonporous, and is preferably nonporous.

The ion exchange membrane can have a thickness of, for example, 50 to 300 micrometers. Within this range, the thickness can be 50 to 200 micrometers, or 50 to 150 micrometers, or 50 to 100 micrometers, or 50 to 90 micrometers, or 60 to 90 micrometers, or 65 to 85 micrometers, or 70 to 80 micrometers. In an aspect, the membrane can be calendered to obtain a desired thickness. The calendered ion exchange membrane can have a thickness of 40 to 200 micrometers, or 40 to 150 micrometers, or 40 to 100 micrometers, or 40 to 90 micrometers, or 50 to 80 micrometers, or 50 to 70 micrometers, or 55 to 65 micrometers.

The ion exchange membrane of the present disclosure can exhibit one or more advantageous properties. For example, the ion exchange membrane can have a tensile stress at break of 25 to 60 megapascal (MPa). The ion exchange membrane can have a tensile elongation at break of 5 to 15%. The ion exchange membrane can have an area resistance of 0.45 to 4 Ohms per centimeter squared (Ωcm²). The ion exchange membrane can exhibit one or more of the foregoing properties.

In an aspect, calendering the ion exchange membrane can provide a further improvement in one more properties. For example, when the membrane is calendered, the membrane can exhibit one or more of: an increase in tensile stress at break of at least 10%, or at least 20%, or at least 25% compared to the tensile stress at break of an ion exchange membrane having the same composition which has not been calendered; a decrease in area resistance of at least 30%, or at least 40%, or at least 50% compared to the area resistance of an ion exchange membrane having the same composition which has not been calendered; a coulombic efficiency of 93% or more at a current density of 40 mA cm⁻²; a coulombic efficiency of 96% or more at a current density of 100 mA cm⁻²; or an energy efficiency of 90% or more at a current density of 40 mA cm⁻².

In a specific aspect, the ion exchange membrane can comprise 50 to 60 weight percent of the fluorinated polymer based on the total weight of the ion exchange membrane; and 40 to 50 weight percent of the cellulose nanocrystals based on the total weight of the ion exchange membrane; wherein the fluorinated polymer comprises poly(vinylidene fluoride-hexafluoropropylene); wherein the ion exchange membrane has a thickness of 50 to 100 micrometers; and wherein the ion exchange membrane exhibits one or more of: a tensile stress at break of 25 to 60 MPa; a tensile elongation at break of 5 to 15%; or an area resistance of 0.45 to 4 Ωcm⁻².

In another specific aspect, the ion exchange membrane can comprise 50 to 60 weight percent of the fluorinated polymer based on the total weight of the ion exchange membrane; and 40 to 50 weight percent of the cellulose nanocrystals based on the total weight of the ion exchange membrane; wherein the fluorinated polymer comprises poly(vinylidene fluoride-hexafluoropropylene); wherein the ion exchange membrane has a thickness of 50 to 100 micrometers; wherein the ion exchange membrane is a calendered film. The calendered ion exchange membrane can exhibit one or more of an increase in tensile stress at break of at least 10%, or at least 20%, or at least 25% compared to the tensile stress at break of an ion exchange membrane having the same composition which has not been calendered; a decrease in area resistance of at least 30%, or at least 40%, or at least 50% compared to the area resistance of an ion exchange membrane having the same composition which has not been calendered; a coulombic efficiency of 93% or more at a current density of 40 mA cm⁻²; a coulombic efficiency of 96% or more at a current density of 100 mA cm⁻²; or an energy efficiency of 90% or more at a current density of 40 mA cm⁻².

The ion exchange membrane of the present disclosure can be useful for a variety of applications. For example, the membrane can be for use in a fuel cell, sensor, electrolytic cell, redox flow battery, gas separator, humidifier, or metal ion batteries. An aspect of the disclosure accordingly includes a fuel cell, sensor, electrolytic cell, redox flow battery, gas separator, humidifier, or metal ion battery including the ion exchange membrane.

Another aspect of the present disclosure is a flow battery comprising the ion exchange membrane. The flow battery can comprise a first compartment comprising an anolyte (i.e., a negative electrolyte) and a second compartment comprising a catholyte (i.e., a positive electrolyte), wherein the first and second compartments are separated by a separator comprising the ion exchange membrane of the present disclosure. The first compartment can be a negative electrode cell comprising a negative electrode and the anolyte and the second compartment can be a positive electrode cell comprising a positive electrode and the catholyte. The anolyte and catholyte are solutions comprising electrochemically active components in different oxidation states. The electrochemically active components in the catholyte and anolyte couple as redox pairs. The anolyte and catholyte can each independently comprise an active material comprising Al, Ca, Ce, Co, Cr, Fe, Mg, Mn, Mo, Si, Sn, Ti, V, W, Zn, Zr, or a combination thereof.

In an aspect, the flow battery can be a vanadium redox flow battery. A vanadium redox battery is a battery capable of charging and discharging utilizing an oxidation-reduction reaction of vanadium as an active material. The electrolyte solutions for use in the vanadium redox flow battery can be aqueous solutions with a vanadium concentration 0.5 to 8.0 mols/liter, or 0.6 to 6.0 mols/liter, or 0.8 to 5.0 mols/liter, or 1.0 to 4.5 mols/liter, or 1.0 to 4.0 mols/liter, or 1.0 to 2.0 mols/liter. An aqueous solution containing sulfuric acid and vanadium can be preferred as an electrolytic solution, wherein the aqueous solution has a sulfate group in a concentration of, for example, 0.5 to 9.0 mols/liter, or 0.8 to 8.5 mols/liter, or 1.0 to 8.0 mols/liter, or 1.2 to 7.0 mol/liter, or 1.5 to 6.0 mols/liter. In an aspect, the catholyte can comprise an aqueous solution comprising a tetravalent vanadium ion, a pentavalent vanadium ion, or a combination thereof. The anolyte can comprise an aqueous solution comprising a divalent vanadium ion.

Another aspect of the present disclosure is a method of making the ion exchange membrane. The method comprises coating a solution comprising a solvent, the fluorinated polymer, and the filler comprising the cellulose nanocrystals onto a substrate, removing the solvent from the coated substrate to provide the membrane, and removing the membrane from the substrate. The method can optionally further comprise calendering the membrane. An exemplary method of making the ion exchange membrane is further described in the working examples below.

Solvents useful for preparing the coating solutions can include any solvent capable of dissolving the fluorinated polymer and dissolving or dispersing the cellulose nanocrystals to provide a homogenous solution. Exemplary solvents can include polar organic solvents, preferably polar aprotic organic solvents, for example dimethylformamide, N-methylpyrrolidone, dimethyl sulfoxide, and the like, or a combination thereof.

Coating the solution on the substrate can be by any solution casting technique, for example spray coating, wiping using a saturated sponge or cloth, solvent casting, spin coating, drop casting, roller coating, wire-bar coating, dip or immersion coating, ink jetting, doctor blading, tape casting, flow coating, and the like. Coating the solution on the substrate can optionally be repeated until the desired membrane thickness is obtained. After coating, the coating can be dried to remove the solvent from the coating. Solvent can be removed by air drying, or by drying in an oven at a temperature of, for example, 50 to 100 degrees Celsius (° C.), optionally at reduced pressure. Suitable drying conditions can be selected based on the solvent to be removed. After removing the solvent, the membrane can then be removed from the substrate, for example by peeling, to provide a free-standing membrane, which can optionally be calendered. The membrane can be washed after removal, for example with water, optionally at a temperature of 50 to 100° C. The membrane can be ionized by immersion in an acidic aqueous solution, for example an aqueous solution of sulfuric acid.

Various embodiments will now be described. In an embodiment, an ion exchange membrane includes: a matrix comprising a fluorinated polymer, in particular poly(vinylidene fluoride-hexafluoropropylene), poly(tetrafluoroethylene), or a combination thereof; and a filler comprising cellulose nanocrystals, and preferably further comprising a particulate alumina, silica, titania, boehmite, zirconium oxide, or a combination thereof, wherein the membrane has a thickness of 50 to 300 micrometers, and preferably, the membrane is a calendared film having a thickness from 40 to 200 micrometers. In this embodiment, the membrane may include 20 to 70 weight percent, or 40 to 70 weight percent of the matrix comprising the fluorinated polymer based on the total weight of the ion exchange membrane; and 30 to 80 weight percent, or 30 to 60 weight percent of the cellulose nanocrystals based on the total weight of the ion exchange membrane. The membrane can exhibits all of a tensile stress at break of 25 to 60 MPa; a tensile elongation at break of 5 to 15%; and an area resistance of 0.45 to 4 Ωcm⁻². The membrane can be for use in a fuel cell, sensor, electrolytic cell, redox flow battery, gas separator, humidifier, or metal ion batteries. An aspect of the disclosure accordingly includes a fuel cell, sensor, electrolytic cell, redox flow battery, gas separator, humidifier, or metal ion battery including the ion exchange membrane

In an embodiment, the ion exchange membrane of claim includes 50 to 60 weight percent of poly(vinylidene fluoride-hexafluoropropylene) based on the total weight of the ion exchange membrane; and 40 to 50 weight percent of the cellulose nanocrystals based on the total weight of the ion exchange membrane, the ion exchange membrane has a thickness of 50 to 100 micrometers; and the ion exchange membrane exhibits all of a tensile stress at break of 25 to 60 MPa; a tensile elongation at break of 5 to 15%; and an area resistance of 0.45 to 4 Ωcm⁻². In this embodiment, the ion exchange membrane is a calendered film having an increase in tensile stress at break of at least 10%, or at least 20%, or at least 25% compared to the tensile stress at break of an ion exchange membrane having the same composition that has not been calendered; a decrease in area resistance of at least 30%, or at least 40%, or at least 50% compared to the area resistance of an ion exchange membrane having the same composition which has not been calendered; a coulombic efficiency of 93% or more at a current density of 40 mA cm⁻²; a coulombic efficiency of 96% or more at a current density of 100 mA cm⁻²; and an energy efficiency of 90% or more at a current density of 40 mA cm⁻². The membrane can be for use in a fuel cell, sensor, electrolytic cell, redox flow battery, gas separator, humidifier, or metal ion batteries. An aspect of the disclosure accordingly includes a fuel cell, sensor, electrolytic cell, redox flow battery, gas separator, humidifier, or metal ion battery including the ion exchange membrane

This disclosure is further illustrated by the following examples, which are non-limiting.

### EXAMPLES

The following examples demonstrate the preparation and characterization of a membrane composed of cellulose nanocrystals (CNC) in a matrix of poly(vinylidene fluoride-co-hexafluoropropylene) (PVDF-HFP). Both the PVDF-HFP and CNC are stable in the harsh oxidative environment of acidic aqueous redox flow batteries (RFBs) due to the high crystallinity of both the polymers and the conduction of protons. In the two-phase composite membrane, CNC provides high hydrophilicity to the membrane due to its excellent wettability, whereas the PVDF-HFP fibril network affords flexibility and mechanical strength to ensure successful RFB operation. Advantageously, the cost of the composite membrane of the present examples is significantly lower than known alternatives such as NAFION (DuPont) owing to the low cost of the starting materials and vast abundance of the natural biopolymer cellulose. The membrane of the following examples exhibited superior cycling performance in the RFB while preserving similar charge-discharge over potential compared to NAFION 115.

### Cellulose Nanocrystal Synthesis

The preparation of cellulose nanocrystals (CNCs) was accomplished by acid-catalyzed hydrolysis. The hydrolysis of microcrystalline cellulose (obtained from Sigma) was conducted by adding 50 grams of microcrystalline cellulose to 500 milliliters of 64.0 wt % sulfuric acid (Sigma), and the mixture was stirred continuously. The temperature was maintained at 50° C. for one hour, and the reaction was stopped by quenching the solution with 5 liters of water. The obtained mixture was kept at room temperature to allow the CNC to settle and the excess water was carefully removed from the solution. The suspension was then washed with deionized water by repeated centrifuging, where the supernatant was collected and dialyzed in deionized water for at least 7 days using regenerated cellulose dialysis membranes with a molecular weight cutoff of 12,000 to 14,000 g/mol.

### Membrane Preparation

The obtained CNC in deionized water was first sonicated for 2 hours and then freeze-dried to acquire dried CNC flakes. To prepare the CNC/PVDF-HFP composite membrane, the freeze-dried CNC flakes were first dispersed in dimethylformamide (DMF, obtained from Sigma) by mixing vigorously for 1 hour and then added to a 10 wt % poly(vinylidene fluoride-co-hexafluoropropylene) (PVDF-HFP, obtained from Sigma) in DMF solution according to the desired weight ratio of CNC and PVDF-HFP. The mixture was probe sonicated (400 watts, 20 kHz, Sonic) for 1 hour in an ice bath at 20% amplitude with a consecutive 1-second pulse and 1-second rest. The solution becomes clear after sonication and the viscosity of the solution after sonication was adjusted by adding additional DMF. The as-prepared solution was cast using a Compact Tape Casting Coater (MTI Corporation) at a low speed on a glass substrate, and the thickness of the casting blade was adjusted to 150 μm. Further, the casted membrane was dried at 60° C. for 48 hours in an oven to remove the solvent. The membrane was then peeled from the substrate at room temperature to provide a freestanding membrane. The freestanding membrane was then calendered to get the final membrane. The membranes were then treated in deionized water at 85° C. for 15 minutes, followed by soaking in 5 wt % hydrogen peroxide (Fisher Scientific) for 30 minutes and finally immersed for 30 minutes in a 0.1 M sulfuric acid solution for ion exchange. The treated membranes were stored in deionized water at room temperature.

### Characterization

The morphology of the membranes was investigated using a Zeiss Supra 25 SEM using 5 keV accelerating voltage. The cross sections of the membranes were prepared by cutting the membranes in liquid nitrogen and sputter coating prior to imaging. Transmission electron microscopy (TEM) images of CNC were taken using a JEM-1010 transmission electron microscopy (JEOL, Japan) at an accelerating voltage of 80 keV. The sample was prepared by dropping a diluted CNC solution on a 300-mesh copper grid coated with carbon film and then negatively staining with 1.5 wt % phosphotungstic acid. Further, the morphology of CNC was also investigated using an atomic force microscope (AFM) (Parks Scientific XE7) in the noncontact imaging mode. To prepare the sample, 10 μL of 0.001 wt % CNC suspension was deposited onto a silica surface and air-dried. The X-ray diffraction (XRD) patterns of the samples were recorded for 20 ranging from 5° to 60° on PANalytical/Philips X'Pert Pro with Cu Kα radiation. The FTIR spectra of the membranes were recorded using a Nicolet FTIR 5700 spectrophotometer (Bruker, Germany) in transmission mode over the range of 500 to 4000 cm⁻¹ with a 4 cm⁻¹ resolution at 25° C. The mechanical properties of the membranes were tested using an Instron testing system at 25° C. at a constant crosshead speed of 5 mm/min with samples having dimensions of 5 mm×15 mm.

The area resistance of the prepared membranes was measured from the static flow cell assembled using graphite felt electrode with an active area of 5 cm². 1 M VOSO₄ in 3 M H₂SO₄ was injected into the cell before each test. Electrochemical impedance spectroscopy using a Biologic SP 150 potentiostat was conducted by applying a sine voltage waveform of amplitude 10 mV added to an offset voltage with and without a membrane, and corresponding resistances can be denoted as R1 and R2. The frequency of the sine voltage was varied stepwise from 1 MHz to 100 MHz, with 6 points per decade in logarithmic spacing. The area resistance R was calculated by the following equation: R=(R1−R2)×A, where A is an active area of the membrane.

The permeability of vanadium (VO²⁺) was detected to characterize the ion selectivity of the membranes and a diffusion cell, where the two chambers are separated by a membrane, was used to evaluate the permeability of vanadium ions through the membranes. One chamber was filled with 10 mL 1 M VOSO₄ in a 3 M H₂SO₄ aqueous solution, and the other chamber was filled with 10 mL 3 M H₂SO₄ aqueous solution. A sample of 500 μL solution from the H₂SO₄ filled chamber was collected at a regular time interval and 500 μL fresh solution was then added to the same chamber to maintain the equal volume at both sides. The absorbance of each sample at 760 nm wavelength was detected using a UV-vis spectrometer (Agilent 8453, USA). A calibration curve of VOSO₄ was obtained at 760 nm wavelength, and vanadium concentration corresponding to each measured absorbance was calculated using the calibration curve.

The membrane was tested in a flow cell according to the following procedure. The active area of the electrodes at both sides was 5 cm². The graphite felt electrodes were treated at 1000° C. for 2 hours in an inert environment, followed by a treatment in air at 400° C. for 10 hours. The electrolytes were pumped at a flow rate of 20 mL min⁻¹ using a peristaltic pump, and the flow rate was kept constant for all the experiments. The negative side was sparged with nitrogen gas before running and appropriately sealed to prevent oxygen exposure. Initially, the electrolytes were prepared by dissolving 1 M VOSO₄ (Aldrich, 99%) in 3 M H₂SO₄ (Aldrich, 97%) solution. To prepare the positive and negative side electrolytes, the cell was charged at a constant voltage of 1.75 V until the current dropped below 5 mA, which is an indication of complete conversion to V(V) and V(II) on the positive and negative sides, respectively. The electrochemical charge-discharge of the flow cell was conducted using a potentiostat (LAND) under a constant current density ranging from 40 to 100 mA cm⁻².

### Results and Discussion

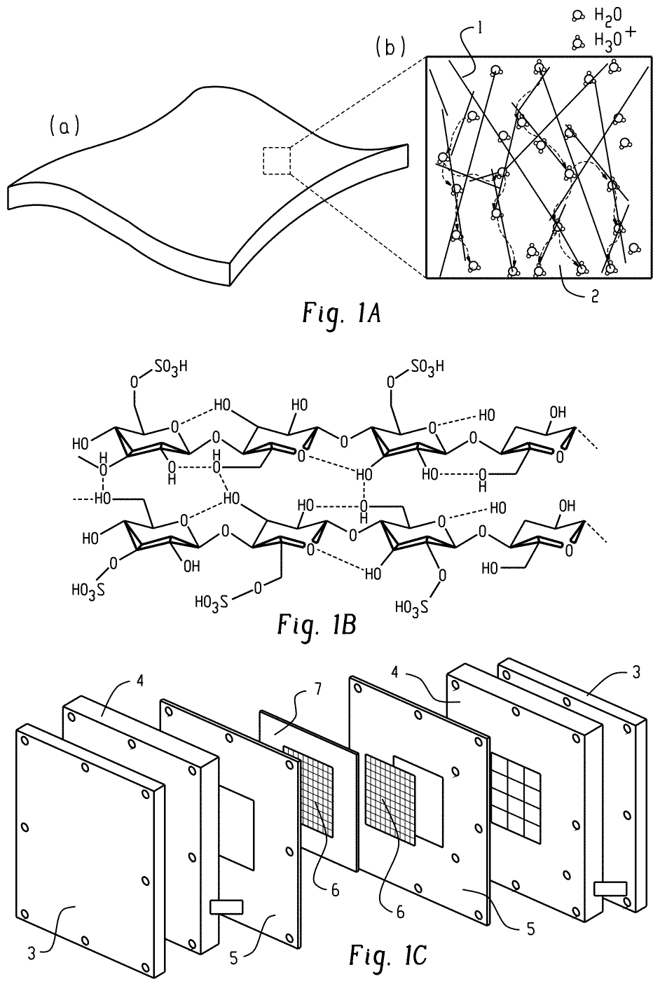

As described above, the membrane used in the present examples was composed of CNC in a fibril PVDF-HFP matrix, prepared by solution casting the CNC/PVDF-HFP mixture, followed by calendaring into a homogenous flat sheet form, as depicted in FIG. 1A. During calendering, the PVDF-HFP was fibrillated and formed a robust matrix that can accommodate the CNC very well and create a uniform hydrophilic/hydrophobic microstructure. In addition, the submicrometer size and high aspect ratio of CNC (1) assist in achieving high selectivity by offering interconnected hydrophilic ionic nanochannels through a hydrophobic matrix (2), as shown in FIG. 1A, which prevents vanadium crossover, but facilitates the proton conduction across the membrane. The protons in the ion exchange membranes are predominantly transported by a combination of vehicle and Grotthuss mechanisms. The vehicle mechanism involves ion diffusion with the carrier to transport acidic or basic media-solvated ions and a counter flow of nonionic carrier to continue the transport. The ion transportation through Grotthuss mechanism, which is much faster than the vehicle mechanism, occurs by forming and breaking hydrogen bonds with ion acceptors/donors such as water molecules. Additionally, the Grotthuss mechanism also conducts ions along the cation or anion exchange groups from one moiety to another. Therefore, the content of cation/anion exchange groups, the interconnectivity of the hydrophilic ionic domains, and the acidity/basicity of the ion conducting groups in the membrane are believed to influence the ionic conductivity of the membrane. Interestingly, cellulose contains numerous pendant hydroxyl (—OH) groups (four in each repeat unit) and part of the surface —OH groups are converted to highly acidic sulfonic acid (—SO₃H) groups, as shown in FIG. 1B during the hydrolysis of the cellulose fibers using sulfuric acid to prepare the CNC. In addition, the structure of the CNC is stabilized by the intramolecular hydrogen bond network extending from the hydroxyl of one unit to the oxygen of the other unit. Thus, CNC meets all the criteria of attaining high proton conductivity. The electrochemical performance of RFB using CNC/PVDF-HFP composite membrane was also evaluated using a vanadium redox flow battery (VRFB), as shown in FIG. 1C. In FIG. 1C, the vanadium redox flow battery includes an end plate (3), a current collector (4), an electrode (5), felt (6), and the ion-selective membrane (7).

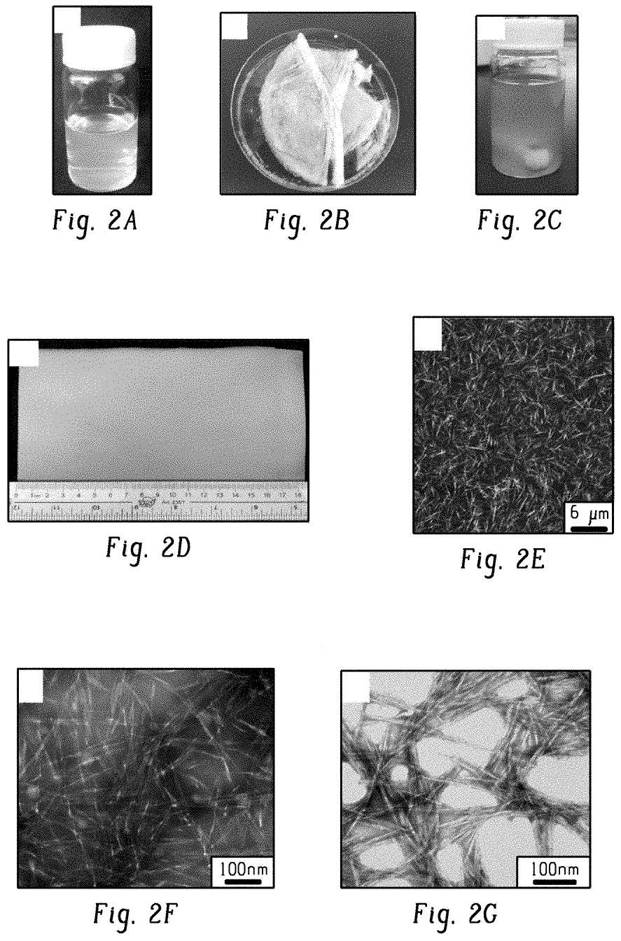

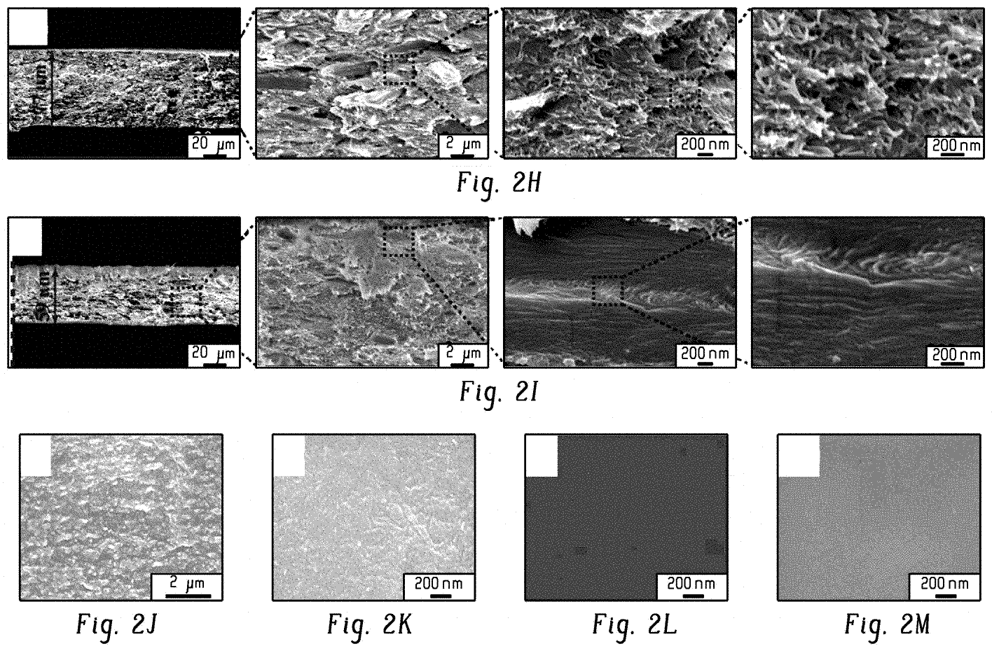

The primary process for isolation of CNC from cellulose fiber is based on the acid hydrolysis, where the disordered or paracrystalline regions are preferentially hydrolyzed, but the crystalline regions remain intact owing to their high resistance to the acid attack. Sulfuric acid reacts with the surface hydroxyl groups of cellulose to yield surface sulfonate groups when sulfuric acid is used for hydrolysis, and these sulfonate groups enable dispersion of CNC in water, as shown in FIG. 2A. Further, to disperse CNC in DMF, the aqueous dispersion of CNC was freeze-dried to form solid CNC (FIG. 2B), which was mixed with the 10 wt % PVDF-HFP solution in DMF at a varying weight percent (ranging from 40 to 50 wt %). A high-intensity probe sonication was used to obtain a homogenous blend of CNC/PVDF-HFP in DMF, as illustrated in FIG. 2C. The shear blended CNC/PVDF-HFP solution was cast using an automatic casting coater, and after solvent evaporation, it was calendered to obtain the final membrane. The membrane was prepared at a large scale, as shown in FIG. 2D, which exhibits a homogenous surface without any visible pinholes or other defects. Further, to investigate the morphology of CNC, atomic force microscopy (AFM) and transmission electron microscopy (TEM) were used. FIG. 2E displays the height mode image of CNC highlighting the morphology and size distribution. The TEM images of CNC at different magnifications (FIG. 2F and FIG. 2G) demonstrate a rod-like morphology of CNC (3 to 5 nm in width and 100 to 200 nm in length), which verifies the high aspect ratio of the CNC. Without wishing to be bound by theory, the high aspect ratio of CNC is believed to be exceptionally beneficial for forming an interconnected hydrophilic nanochannel that promotes the proton conduction through the membrane.

The scanning electron microscope (SEM) images of the cross-section and surface of the CNC/PVDF-HFP composite membrane before and after calendering were also obtained to investigate the morphology of the as-prepared membrane. Before calendering, the cross-section images of the membrane displayed a uniform and homogenous morphology (FIG. 2H), but the appearance of micro- and nanovoids are apparent. On the other hand, the CNC/PVDF-HFP composite membrane appears to be denser and uniform with no visible holes even at higher magnifications, as depicted in FIG. 2I, and quite similar to the morphology of the cross-section of NAFION 115 (FIG. 2J). The surface morphology of the CNC/PVDF-HFP composite membranes appears to be coarse before calendering (FIG. 2K) compared to the membrane after calendering (FIG. 2L). However, no visible differences in the surface morphologies of the CNC/PVDF-HFP composite membrane after calendering and NAFION 115 (FIG. 2M) were observed. Therefore, it is evident that the calendaring process aids in eliminating the micro- and nanovoids, making the membrane more uniform and denser, which, without wishing to be bound by theory, is believed to further assist in achieving high ionic selectivity by preventing the vanadium crossover through the defects.

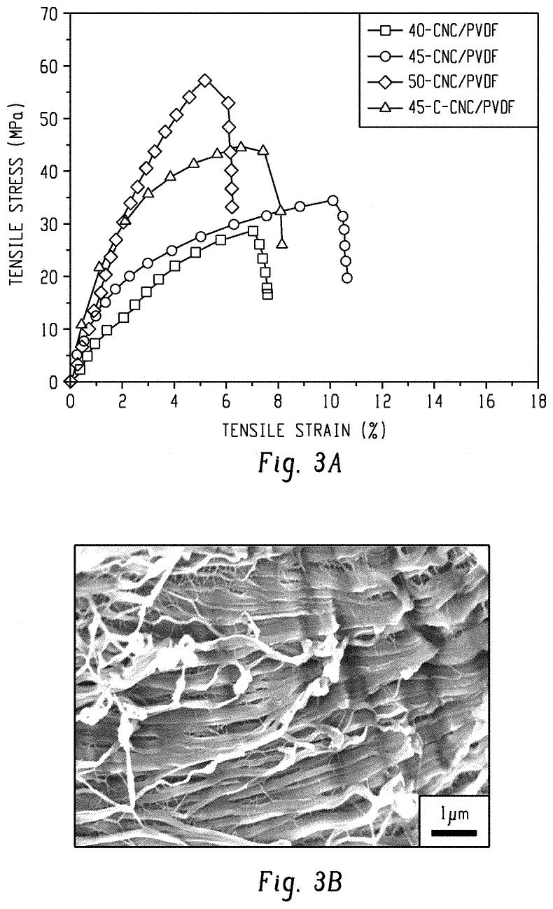

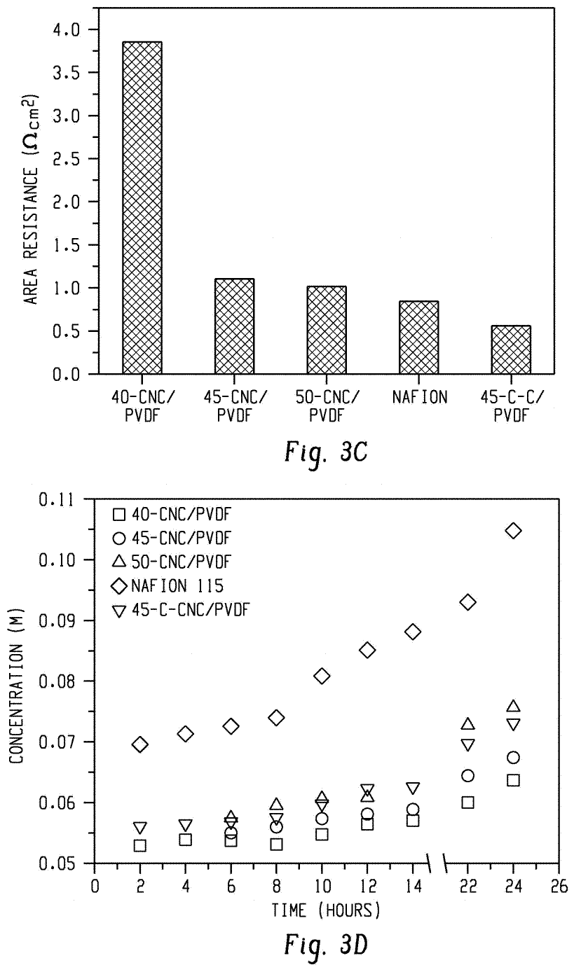

To investigate if the mechanical properties of the CNC/PVDF-HFP composite membranes are satisfactory for implementing in RFB, typical tensile stress-strain curves were evaluated. The different weight percent containing CNC samples are designated as X-CNC/PVDF, where X represents the weight percent of CNC in the membrane, and the thickness of all the membranes was kept the same (75±5 μm). The calendered membranes were designated as X-C-CNC/PVDF and thickness of the calendered membrane was kept constant at 60 μm. FIG. 3A exhibits the stress-strain curves for 40-CNC/PVDF, 45-CNC/PVDF, 50-CNC/PVDF, and 45-C-CNC/PVDF composite membranes, where they achieved breaking stresses of 28.45, 34.41, 57.85, and 44 MPa and elongations at break of 7.2, 10.1, 5.2, and 7.5%, respectively. It is apparent that with the increasing CNC content, the tensile strength increased and a reinforcing effect was observed. A loss in ductility was also observed, which can be attributed to the high rigidity and increased crystallinity of PVDF-HFP. The 45-CNC/PVDF displayed the highest elongation at break with decent tensile stress and therefore was used for calendering. The elongation at break was further reduced and the tensile strength was increased for 45-C-CNC/PVDF due to the increase in density of the membrane after calendering. The SEM image (FIG. 3B) of the fractured region of 45-C-CNC/PVDF evidence that the CNC enmeshed in fibril PVDF-HFP network increases the overall mechanical properties, making it suitable for its use in RFB.

The area resistance of the membranes governs the ohmic potential drop across the membrane and therefore can impact the overall performance of the battery. The obtained values for the area resistances for the tested samples are 3.85, 1.10, 1.00, 0.85, and 0.55 Ωcm² for 40-CNC/PVDF-HFP, 45-CNC/PVDF-HFP, 50-CNC/PVDF-HFP, NAFION 115, and 45-C-CNC/PVDF-HFP, respectively, indicating a decrease in the area resistance with the increasing CNC content, which can be attributed to the highly interconnected hydrophilic nanocluster formation by the intrinsic ion exchange (—SO₃H and —OH) groups of CNC (FIG. 3C). It is worth noting that the 45-C-CNC/PVDF-HFP displayed the lowest area resistance among the others including NAFION 115, as the thickness decreases to 59 μm after calendering, which in turn reduces the ohmic loss in the flow cell arising from the membrane. In addition, the rate of vanadium ion (VO²⁺) permeation was also measured, as shown in FIG. 3D, in a diffusion cell to verify the selectivity of the membranes, where a reverse trend of increasing VO²⁺ permeation rate with the increase in CNC content was observed. Although, all the CNC/PVDF-HFP membranes exhibited significantly lower vanadium permeation compared to the NAFION 115, irrespective of being significantly thinner, indicating excellent selectivity of the CNC/PVDF-HFP membranes due to the homogenous distribution and nanosize of the CNC. Overall, owing to the high proton conductivity with the excellent VO²⁺ ion inhibition, the 45-C-CNC/PVDF-HFP membrane consequently is expected to achieve impressive battery performance.

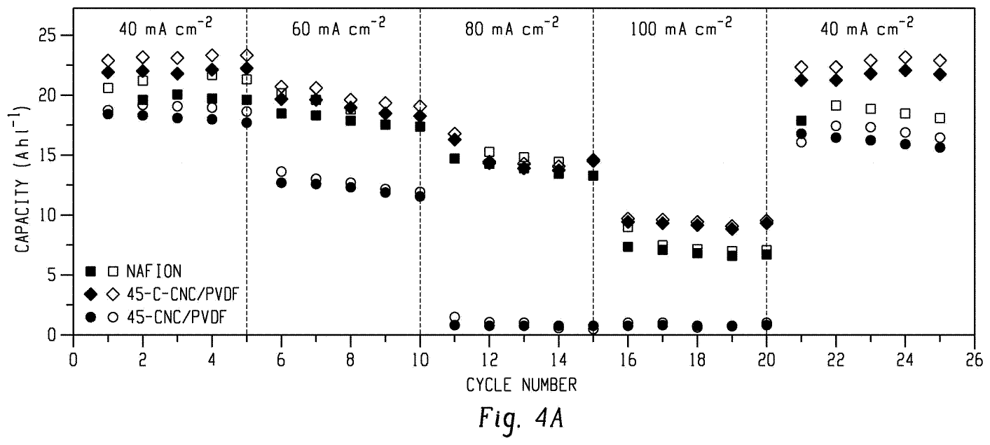

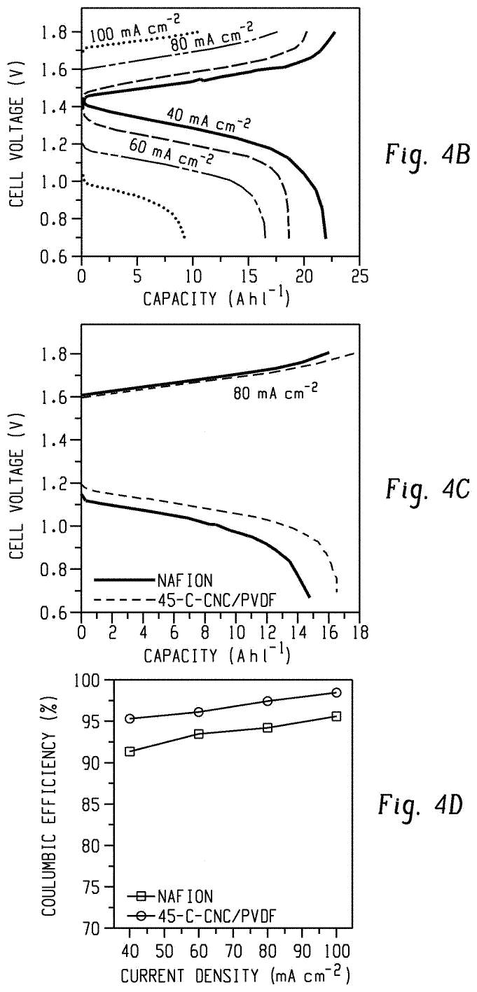

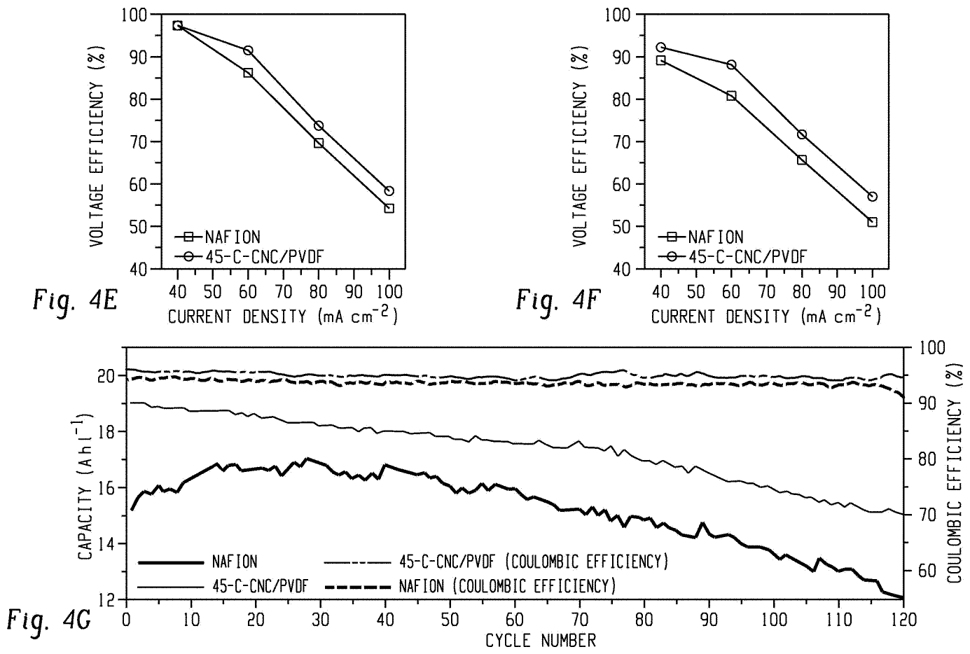

Furthermore, combining excellent ion selectivity and proton conductivity, the flow cell assembled using 45-C-CNC/PVDF-HFP membrane displayed excellent electrochemical performance, as demonstrated in FIG. 4A-G. The current rate performance of the full cell, as shown in FIG. 4A, was achieved by running the cell at four different current densities ranging from 40 mA cm⁻² to 100 mA cm⁻² for five consecutive times at each current density and returned to the initial current density of 40 mA cm⁻², where it regained 100% of its original capacity, indicating outstanding stability attributable to the low vanadium permeability and high chemical stability of the 45-C-CNC/PVDF-HFP membrane. The corresponding charge-discharge profiles of the 45-C-CNC/PVDF-HFP membrane at different current densities, as displayed in FIG. 4B, exhibit the increasing voltage gaps causing a gradual reduction in achieved capacity with the increase in the current density, which can be attributed to the increased ohmic loss and mass transport limitations at higher current densities. FIG. 4C demonstrates the charge-discharge profiles of 45-C-CNC/PVDF-HFP membrane compared with the NAFION 115 membrane at the same current density of 80 mA cm⁻² and both of the membranes exhibit similar overpotential, which is also consistent with the previously obtained ASR values for 45-C-CNC/PVDF-HFP (0.55 Ωcm⁻²) and NAFION 115 membranes (0.85 Ωcm⁻²).

Remarkably, the 45-C-CNC/PVDF-HFP membrane demonstrated exceptionally high coulombic efficiencies (CE) of 95.36, 95.94, 97.38, and 98.36 at the current densities of 40, 60, 80, and 100 mA cm⁻², whereas NAFION 115 membrane achieved coulombic efficiencies of 91.4, 93.5, 94.36, and 95.56 at similar current densities (FIG. 4D), attributable to the excellent ion selectivity of the 45-C-CNC/PVDF-HFP membrane leading to negligible vanadium crossover. It is worth mentioning that the CE increases with the increase in the current density due to the shorter charge-discharge time at high current densities. However, a reverse trend of declining voltage efficiencies (VE) with the increasing current density was observed because of the higher ohmic polarization and overpotential. Consequently, the obtained VE (FIG. 4E) at similar operating cell conditions for 45-C-CNC/PVDF-HFP are 96.65, 90.86, 73.42, and 57.98% and for NAFION 115 are 96.49, 85.40, 69.10, and 53.40% at similar current densities of 40, 60, 80, and 100 mA cm⁻², which can be ascribed to the enhanced proton conductivity of the 45-C-CNC/PVDF-HFP membrane. Meanwhile, the 45-C-CNC/PVDF-HFP membrane demonstrates energy efficiencies (EE) of 91.20, 87.08, 70.76, and 57.02% at current densities of 40, 60, 80, and 100 mA cm⁻², while the EE for NAFION 115 are 88.19, 79.85, 65.20, and 51.03% at similar current densities, as shown in FIG. 4F. As anticipated, the obtained EE for 45-C-CNC/PVDF-HFP membranes is indeed higher than the NAFION 115 membranes, which are also consistent with the ASR and vanadium permeability results, due to the synergetic effect of the high proton conductivity contributed by the CNC and negligible vanadium crossover of the 45-C-CNC/PVDF-HFP membrane. To further investigate the chemical stability of the 45-C-CNC/PVDF-HFP, a VRFB assembled using a 45-C-CNC/PVDF-HFP membrane was continuously cycled at a constant current density of 40 mA cm⁻², as depicted in FIG. 4G. The battery with the 45-C-CNC/PVDF-HFP membrane demonstrated excellent capacity retention of more than 80% of its initial capacity even after 120 cycles without any decay in CE, indicating excellent chemical stability attributable to the highly crystalline nature of the CNC. On the other hand, the NAFION 115 membrane retained only 72% of its initial capacity after 120 cycles. It is worth noting that the preparation of CNC involves hydrolysis of cellulose in strong sulfuric acid, where, the disordered or paracrystalline regions of cellulose are preferentially hydrolyzed, but the crystalline regions remain intact owing to their higher resistance to the acid attack, and therefore, are highly stable in the corrosive acidic and oxidizing environment.

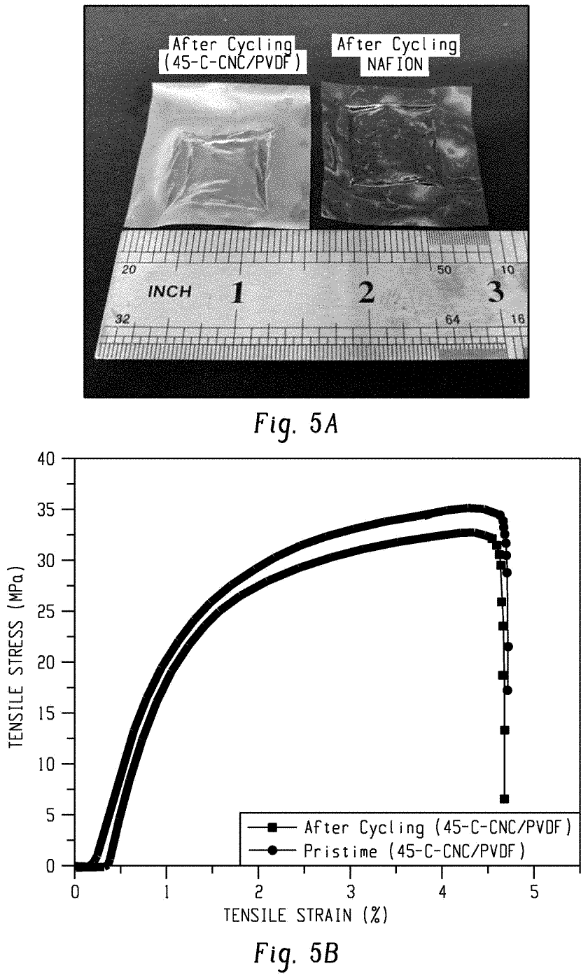

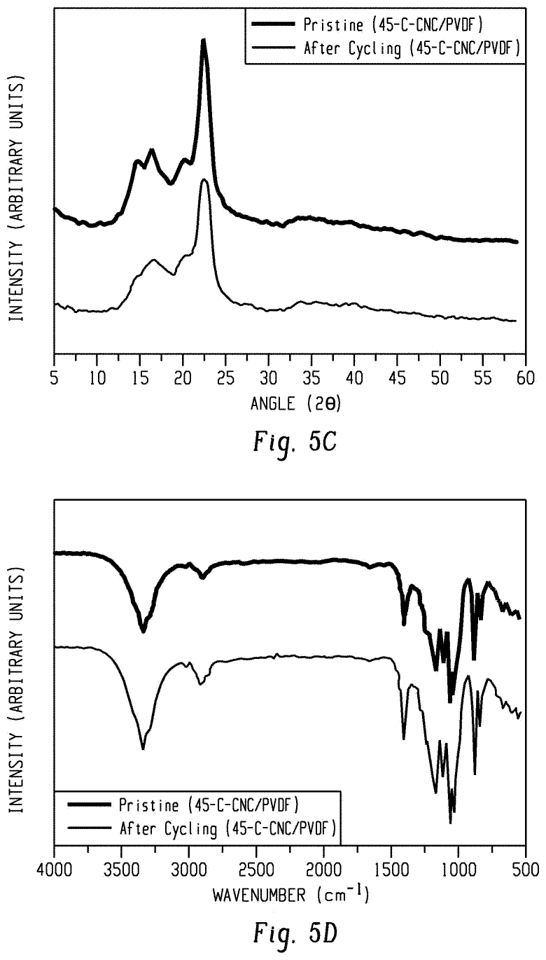

To further confirm the chemical stability of the 45-C-CNC/PVDF-HFP membrane a postmortem analysis of the membrane was conducted after using the membrane for 120 cycles by obtaining the X-ray diffraction patterns (XRD) and Fourier-transform infrared (FTIR) spectra, shown in FIG. 5A-D. The 45-C-CNC/PVDF-HFP membrane was observed to retain its structural integrity and robustness without any noticeable changes after exposure to the harsh oxidizing environment for more than two weeks, verifying excellent shape stability of the membrane. Moreover, the XRD patterns and intensity preservation for the 45-C-CNC/PVDF-HFP membrane after cycling indicates that the CNC can maintain its crystalline structure after cycling of the membrane for a long time in harsh conditions. Indeed, the 45-C-CNC/PVDF-HFP membrane after cycling retained the characteristic diffraction peaks of CNC at 2θ angles at 14.8, 16.4, 20.4, 22.7, and 34.5 corresponding to the reflection planes 1-10, 110, 110, 012, 200, and 004 respectively, as shown in FIG. 5C. Likewise, the absence of any changes in the FTIR spectra of the 45-45-C-CNC/PVDF-HFP membrane before and after cycling (FIG. 5D) also confirms outstanding chemical stability of the membrane. The 45-C-CNC/PVDF-HFP membrane before and after cycling featured distinct hydroxyl group peaks located at 3340 inverse centimeters (cm⁻¹), which corresponds to the O—H stretching of the three hydroxyl groups of cellulose. It is also interesting to note that the peaks at 2900 and 1410 cm⁻¹ correspond to the C—H stretching vibration and —CH₂—(C₆)— bending vibrations, respectively, while the small peak corresponding to the intramolecular hydrogen bonding arises due to the cellulose-water interaction leading to —OH bending of absorbed water at 1640 cm⁻¹. Therefore, the XRD and FTIR results demonstrate that the 45-C-CNC/PVDF-HFP membrane possesses strikingly high chemical stability in the harsh environment of VRFB, which is a significant concern for current non-perfluorinated membranes.

In summary, an effective approach for creating inexpensive composite membrane consisting of CNC enmeshed in a fibril PVDF-HFP matrix, obtained by calendering, was demonstrated. Interestingly, the intrinsic pendant —OH groups and highly acidic —SO₃H groups of CNC construct highly interconnected hydrophilic ionic nanoclusters that impart superior ion conductivity to the membrane by accelerating the proton conduction, which makes cellulose an ideal candidate as a hydrophilic agent in the ion exchange membrane. In addition, high crystallinity of CNC provides exceptionally high chemical stability in the harsh operating condition of RFB, addressing the stability issues of existing non-perfluorinated ion exchange membranes. The VRFB assembled with 45-C-CNC/PVDF-HFP membrane exhibited coulombic efficiency of 96%, energy efficiency of 91%, and stable performance for more than 100 cycles at a current density of 40 mA cm⁻². Therefore, the CNC/PVDF-HFP membrane illustrates the design and fabrication of highly stable ion exchange membranes.

This disclosure further encompasses the following aspects.

Aspect 1: An ion exchange membrane comprising a matrix comprising a fluorinated polymer; and a filler comprising cellulose nanocrystals.

Aspect 2: The ion exchange membrane of aspect 1, wherein the fluorinated polymer comprises poly(chlorotrifluoroethylene), poly(chlorotrifluoroethylene-propylene), poly(ethylene-tetrafluoroethylene), poly(ethylene-chlorotrifluoroethylene), poly(hexafluoropropylene), poly(tetrafluoroethylene), poly(tetrafluoroethylene-ethylene-propylene), poly(tetrafluoroethylene-hexafluoropropylene), poly(tetrafluoroethylene-propylene), poly(tetrafluoroethylene-perfluoropropylene vinyl ether), poly(tetrafluoroethylene-perfluoropropylene vinyl ether), polyvinylfluoride, polyvinylidene fluoride, poly(vinylidene fluoride-chlorotrifluoroethylene), poly(vinylidene fluoride-hexafluoropropylene), perfluoropolyether, perfluorosulfonic acid, and perfluoropolyoxetane, or a combination thereof.

Aspect 3: The ion exchange membrane of aspect 1 of 2, wherein the fluorinated polymer comprises poly(vinylidene fluoride-hexafluoropropylene), poly(tetrafluoroethylene), or a combination thereof.

Aspect 4: The ion exchange membrane of any of aspects 1 to 3, wherein the fluorinated polymer comprises poly(vinylidene fluoride-hexafluoropropylene).

Aspect 5: The ion exchange membrane of any of aspects 1 to 4, wherein the matrix excludes a perfluorosulfonic acid-poly(tetrafluoroethylene) copolymer.

Aspect 6: The ion exchange membrane of any of aspects 1 to 5, wherein the filler further comprises alumina, silica, titania, boehmite, zirconium oxide, or a combination thereof.

Aspect 7: The ion exchange membrane of any of aspects 1 to 6, wherein the membrane has a thickness of 50 to 300 micrometers.

Aspect 8: The ion exchange membrane of any of aspects 1 to 7, wherein the membrane is a calendered film with thickness from 40 to 200 micrometers.

Aspect 9: The ion exchange membrane of any of aspects 1 to 8, comprising 40 to 70 weight percent, or 20 to 70 weight percent of the matrix comprising a fluorinated polymer based on the total weight of the ion exchange membrane; and 30 to 60 weight percent, or 30 to 80 weight percent of the cellulose nanocrystals based on the total weight of the ion exchange membrane.

Aspect 10: The ion exchange membrane of any of aspects 1 to 9, wherein the membrane exhibits one or more of: a tensile stress at break of 25 to 60 MPa; a tensile elongation at break of 5 to 15%; or an area resistance of 0.45 to 4 Ωcm⁻².

Aspect 11: The ion exchange membrane of aspect 1, comprising 50 to 60 weight percent of the fluorinated polymer based on the total weight of the ion exchange membrane; and 40 to 50 weight percent of the cellulose nanocrystals based on the total weight of the ion exchange membrane; wherein the fluorinated polymer comprises poly(vinylidene fluoride-hexafluoropropylene); wherein the ion exchange membrane has a thickness of 50 to 100 micrometers; and wherein the ion exchange membrane exhibits one or more of: a tensile stress at break of 25 to 60 MPa; a tensile elongation at break of 5 to 15%; or an area resistance of 0.45 to 4 Ωcm⁻².

Aspect 12: The ion exchange membrane of aspect 11, wherein the ion exchange membrane is a calendered film.

Aspect 13: The ion exchange membrane of aspect 12, wherein the ion exchange membrane exhibits one or more of the following: an increase in tensile stress at break of at least 10%, or at least 20%, or at least 25% compared to the tensile stress at break of an ion exchange membrane having the same composition which has not been calendered; a decrease in area resistance of at least 30%, or at least 40%, or at least 50% compared to the area resistance of an ion exchange membrane having the same composition which has not been calendered; a coulombic efficiency of 93% or more at a current density of 40 mA cm⁻²; a coulombic efficiency of 96% or more at a current density of 100 mA cm⁻²; or an energy efficiency of 90% or more at a current density of 40 mA cm⁻².

Aspect 14: The ion exchange membrane of any of aspects 1 to 13, wherein the membrane is nonporous.

Aspect 15: The ion exchange membrane of any of aspects 1 to 14, wherein the membrane is for use in a fuel cell, sensor, electrolytic cell, redox flow battery, gas separator, humidifier, metal ion batteries.

Aspect 16: A method of making the ion exchange membrane of any of aspects 1 to 15, the method comprising: coating a solution comprising a solvent, the fluorinated polymer, and the cellulose nanocrystals onto a substrate; removing the solvent from the coated substrate to provide the membrane; and removing the membrane from the substrate.

Aspect 17: The method of aspect 16, further comprising calendering the membrane.

Aspect 18. A fuel cell, a sensor, an electrolytic cell, a redox flow battery, a gas separator, a humidifier, or a metal ion battery comprising the ion exchange membrane of any of aspects 1 to 15 or made by the method of any of aspects 16 to 17.

Aspect 19: A flow battery comprising the ion exchange membrane of any of aspects 1 to 15 or made by the method of any of aspects 16 to 17.

Aspect 20: The flow battery of aspect 19, wherein the redox flow battery is a vanadium redox flow battery.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect,” and so forth, means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various embodiments.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. An ion exchange membrane comprising:
a matrix comprising a fluorinated polymer; and
a filler comprising cellulose nanocrystals.

2. The ion exchange membrane of claim 1, wherein the fluorinated polymer comprises poly(chlorotrifluoroethylene), poly(chlorotrifluoroethylene-propylene), poly(ethylene-tetrafluoroethylene), poly(ethylene-chlorotrifluoroethylene), poly(hexafluoropropylene), poly(tetrafluoroethylene), poly(tetrafluoroethylene-ethylene-propylene), poly(tetrafluoroethylene-hexafluoropropylene), poly(tetrafluoroethylene-propylene), poly(tetrafluoroethylene-perfluoropropylene vinyl ether), poly(tetrafluoroethylene-perfluoropropylene vinyl ether), polyvinylfluoride, polyvinylidene fluoride, poly(vinylidene fluoride-chlorotrifluoroethylene), poly(vinylidene fluoride-hexafluoropropylene), perfluoropolyether, perfluorosulfonic acid, and perfluoropolyoxetane, or a combination thereof.

3. The ion exchange membrane of claim 1, wherein the fluorinated polymer comprises poly(vinylidene fluoride-hexafluoropropylene), poly(tetrafluoroethylene), or a combination thereof.

4. The ion exchange membrane of claim 1, wherein the fluorinated polymer comprises poly(vinylidene fluoride-hexafluoropropylene).

5. The ion exchange membrane of claim 1, wherein the matrix does not include a perfluorosulfonic acid-poly(tetrafluoroethylene) copolymer.

6. The ion exchange membrane of claim 1, wherein the filler further comprises a particulate alumina, silica, titania, boehmite, zirconium oxide, or a combination thereof.

7. The ion exchange membrane of claim 1, wherein the membrane has a thickness of 50 to 300 micrometers.

8. The ion exchange membrane of claim 1, wherein the membrane is a calendered film having a thickness from 40 to 200 micrometers.

9. The ion exchange membrane of claim 1, comprising
20 to 70 weight percent of the matrix comprising a fluorinated polymer based on the total weight of the ion exchange membrane; and
30 to 80 weight percent of the cellulose nanocrystals based on the total weight of the ion exchange membrane.

10. The ion exchange membrane of claim 1, wherein the membrane exhibits one or more of:
a tensile stress at break of 25 to 60 MPa;
a tensile elongation at break of 5 to 15%; or
an area resistance of 0.45 to 4 Ωcm⁻².

11. The ion exchange membrane of claim 1, comprising
50 to 60 weight percent of the fluorinated polymer based on the total weight of the ion exchange membrane; and
40 to 50 weight percent of the cellulose nanocrystals based on the total weight of the ion exchange membrane;
wherein the fluorinated polymer comprises poly(vinylidene fluoride-hexafluoropropylene);
wherein the ion exchange membrane has a thickness of 50 to 100 micrometers; and
wherein the ion exchange membrane exhibits one or more of:
a tensile stress at break of 25 to 60 MPa;
a tensile elongation at break of 5 to 15%; or
an area resistance of 0.45 to 4 Ωcm⁻².

12. The ion exchange membrane of claim 11, wherein the ion exchange membrane is a calendered film.

13. The ion exchange membrane of claim 12, wherein the ion exchange membrane exhibits one or more of the following:
an increase in tensile stress at break of at least 10% compared to the tensile stress at break of an ion exchange membrane having the same composition which has not been calendered;
a decrease in area resistance of at least 30% compared to the area resistance of an ion exchange membrane having the same composition which has not been calendered;
a coulombic efficiency of 93% or more at a current density of 40 mA cm⁻²;
a coulombic efficiency of 96% or more at a current density of 100 mA cm⁻²; or
an energy efficiency of 90% or more at a current density of 40 mA cm⁻².

14. The ion exchange membrane of claim 1, wherein the membrane is nonporous.

15. The ion exchange membrane of claim 1, wherein the membrane is for use in a fuel cell, sensor, electrolytic cell, redox flow battery, gas separator, humidifier, or metal ion battery.

16. A method of making the ion exchange membrane of claim 1, the method comprising:
coating a solution comprising a solvent, the fluorinated polymer, and the cellulose nanocrystals onto a substrate;
removing the solvent from the coated substrate to provide the membrane; and
removing the membrane from the substrate.

17. The method of claim 16, further comprising calendering the membrane.

18. A fuel cell, a sensor, an electrolytic cell, a redox flow battery, a gas separator, a humidifier, or a metal ion battery comprising the ion exchange membrane of claim 1.

19. A flow battery comprising the ion exchange membrane of claim 1.

20. The flow battery of claim 19, wherein the redox flow battery is a vanadium redox flow battery.
